(19) United States
(12) Patent Application Publication
(10) Pub. No.: US 2012/0022898 A1
(43) Pub. Date: Jan. 26, 2012

(54) SYSTEM AND METHOD FOR OBTAINING COMPARATIVE QUOTES

(76) Inventor: Lawrence Koa, Dublin, CA (US)

(21) Appl. No.: 13/011,854

(22) Filed: Jan. 21, 2011

Related U.S. Application Data
(60) Provisional application No. 61/297,029, filed on Jan. 21, 2010.

(51) Int. Cl. G06Q 40/08; G06Q 30/02

(52) U.S. Cl. 705/4; 705/26.4

(57) ABSTRACT

A method and system are disclosed for providing insurance quotes to a user from a plurality of insurance carriers. The method and system provide a quick quote based upon minimal information entered by a user. A system reduces the amount of information that is necessary for the user to obtain a preliminary quote thereby providing feedback to the user and encouraging the user to complete the interview process. The user may select a carrier and then continue to enter additional information necessary for providing a binding quote.

### CROSS REFERENCE TO RELATED APPLICATIONS

This application claims priority to U.S. provisional patent application Ser. No. 61/297,029, filed Jan. 21, 2010, the contents of which is herein incorporated by reference.

### FIELD OF THE INVENTION

The present invention relates to systems for providing automatic and/or online quotes, in particular in respect to online quotes for insurance.

### BACKGROUND

Many websites request a large amount of information from users. For example, insurance websites usually ask users to provide name, address, telephone number, date of birth, social security, level of education, marital status, accident history, criminal history, travel history, medical history and product preferences. The number of questions and the type of questions asked on a web site has a large bearing on the extent to which users complete that site. The fewer the requests for information on a website, the better the chances the user will complete an interview on the site. In addition, if a site asks for personal information, such as address, telephone numbers, social security numbers, date of birth, etc., fewer users will complete the website interview. Therefore, websites that require users to input the least amount of information and the least amount of personal information have high completion rates. High completion rates lead to a greater number of sales, which increases the profitability of a website.

In the insurance industry, some websites use user information to generate insurance quotes. These websites may provide insurance quotes from a plurality of different insurance carriers. In order to generate the quotes, the websites must gather a large amount of information from users, including personal information. The present invention utilizes an internal rating engine that allows users to request quick quotes without having to send personal information. The present invention allows users to obtain quotes for average premiums without having to enter all necessary information to provide a binding quote. For example, if a user only enters a zip code, the present invention can provide the average premium for each carrier in that zip code. This average premium is a quick quote or provisional quote that is not final. The average premium information provides instant feedback, which tends to encourage users to complete the required fields in order to obtain a full quote. The use may then continue the interview to enter all of the necessary information needed to obtain a full and final quote.

In the insurance industry, various variables are used to generate insurance rates. These variables are different for different insurance providers and the variables change over time. In order to provide multiple quotes and compare quotes from different providers, the present invention is capable of requesting information that is necessary to obtain the appropriate quotes. For example, if a first provider requires variables A and B and a second provider requires variables A and C, the present invention can ask the user for A, B and C. However, if the second provider can be ruled out for a particular reason based on the user's information entered in the quick quote stage, then the present invention will only ask the user for A and B.

### SUMMARY OF ONE EMBODIMENT OF THE INVENTION

### Advantages of One or More Embodiments of the Present Invention

The various embodiments of the present invention may, but do not necessarily, achieve one or more of the following advantages:

The ability to have a greater number users to complete an information request interview;

the ability to have a greater number of users complete a insurance quote request interview;

the ability to request less information from users;

the ability to request less personal information from users;

the ability to provide a quick quote to a user;

the ability to provide average premium information to users based on minimal user information;

the ability to use information entered to obtain a quick quote to reduce the amount of information requested from a user;

the ability to provide insurance quotes from a plurality of different insurance providers;

the ability to compare insurance quotes from a plurality of different insurance providers;

the ability to provide final insurance quotes to users using a minimum of user input information; and

provide a system that is capable of providing the above advantages.

These and other advantages may be realized by reference to the remaining portions of the specification, claims, and abstract.

### BRIEF DESCRIPTION OF ONE EMBODIMENT OF THE PRESENT INVENTION

In one embodiment of the present invention a method of request information from a user for an insurance quote using at least one computer and a communication network is provided. The method comprises the computer transmitting over the communication network a request for information relating to at least one variable to a user. The user inputs information. The computer receiving over the communication network input information from the user in response to the request. The computer calculating an average insurance premium based at least in part on the input information. The computer transmitting over the communication network the quick quote insurance information to the user.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of the present invention.

FIG. 2 is substantially a flow chart of a method of the present invention.

FIG. 3 is substantially a flow chart of a method of the present invention.

FIG. 4 is substantially a flow chart of a method of the present invention.

FIG. 5 is substantially a flow chart of a method of the present invention.

FIG. 6 is substantially a screen display of the present invention.

FIG. 7 is substantially a screen display of the present invention.

FIG. 8 is substantially a screen display of the present invention.

FIG. 9 is substantially a flow chart of a method of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

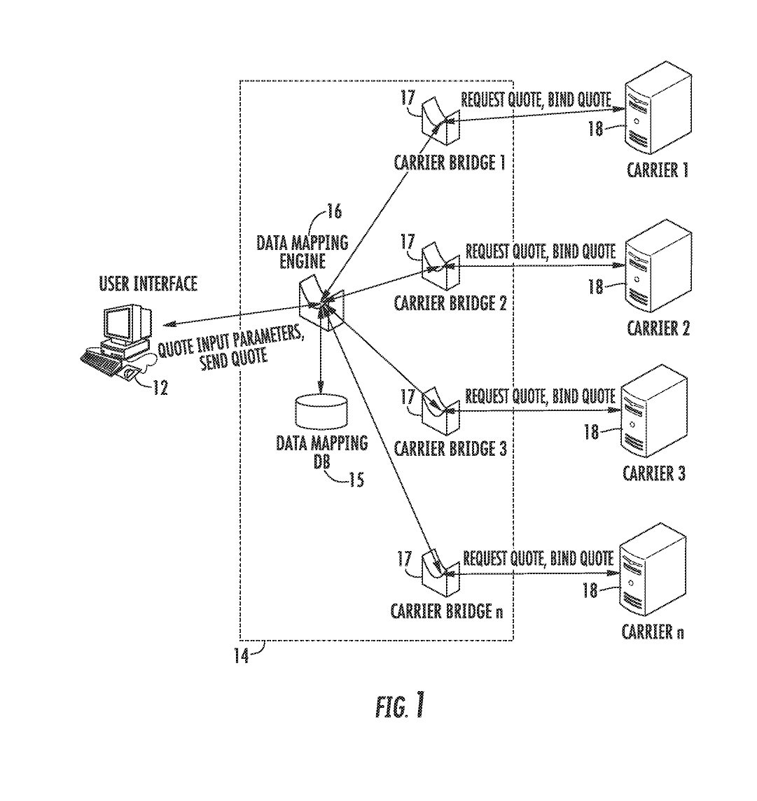

In FIG. 1, there is shown a system 10 that may be used for providing comparative quotes to users from a number of insurance companies (third party providers) and transmitting the quote information to an insurance company selected by the user so that quote can be closed and the policy bound. The system includes a user interface 12 that may be presented to a user through a suitable online service, such as the internet. An interpreter 14 is a middleware system that provides an interpreting interface between a front end user interface 12 and any number of third party service provider systems 18. A function of the interpreter 14 is to ensure and validate that all carrier/market specific rating variables have been accurately entered, not only improving the accuracy of submissions, but also ensuring that these additional data fields can be re-used throughout the comparative shopping process. Another function of the interpreter is to allow the user to transmit or “bridge” quote information to close and bind the policy.

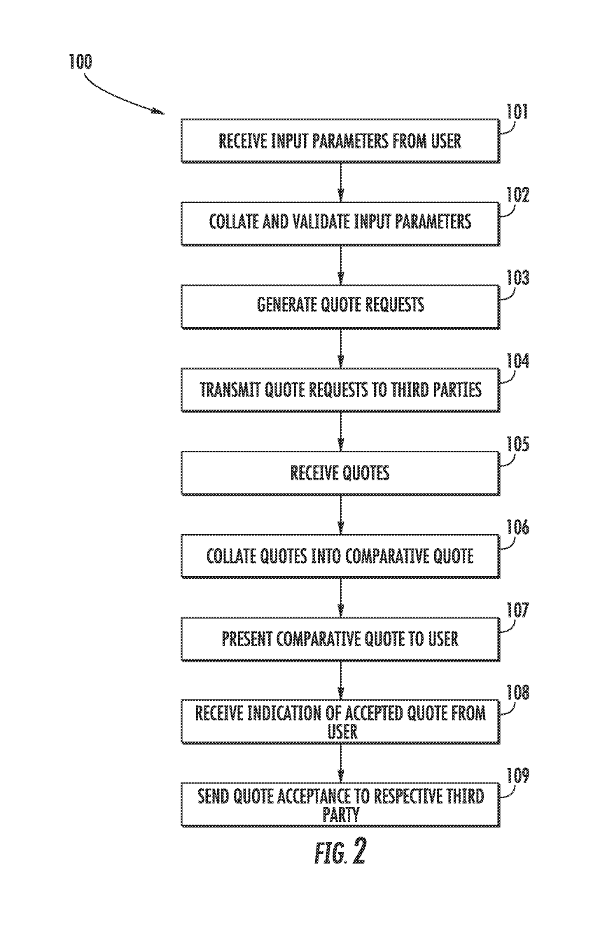

A method for providing comparative quotes to a user is illustrated in the flowchart 100 of FIG. 2. At step 101, a plurality of input parameters are received from the user through the user interface 12. The interpreter 14 then compares, collates and validates the input parameters from the user interface with the required input parameters for each third party system 18 (step 102). It then informs the user interface 12 for any input parameters not yet received that are required by any of the third party systems. The user interface 12 then prompts the user to enter these required input parameters and resends them back to the interpreter 14. The interpreter 14 then converts the input parameters into a plurality of quote requests in a plurality of third party request formats (step 103) and transmits the quote requests to the third party systems 18 (step 104) using a suitable protocol, e.g., HTTP, XML, SOAP, XML webservice, etc. and via respective carrier bridges 17. The third party systems respond with quotes (step 105), which the interpreter 14 collates into a comparative quote (step 106) to be presented to the user (step 107), e.g., by displaying the comparative quote on the user interface 12. At this point, the user interface 12 may prompt the user to select the third party system 18 (carrier) he or she would like to be insured with and send the selected third party system 18 to the interpreter 14 (step 108). The interpreter 14 then resends the quote information to the selected third party system 18 to close and bind the quote (step 109).

The interpreter includes a database 15 that stores a plurality of third party request formats. Each third party request format includes a list of compulsory input parameters, a list of valid values for each input parameter and the format for receiving the quote request. The interpreter presents a display on the user interface such as a web based form that requests information from a user. In an insurance context, the information may include name, address, post code, type of insurance being sought (e.g., home and contents, car, medical insurance, etc), ages of drivers in the household, year, make and model of each vehicle to be insured, etc. Each third party insurance provider may have its own format for receiving quote requests. This may be in the form of an http post, SOAP or web service request. For some insurance providers and some insurance types, it will be compulsory to enter certain types of information. For example, some auto carriers may only require the vehicle's garaging zip code to determine the rating territory but other carriers may require the city, county or township of where the vehicle is garaged. In another example, some carriers require the insured's prior liability coverage limits to appropriately assign an appropriate rating tier for the quote, while others don't. The list of valid values for the same input parameter may be different for each carrier. For example, two auto carriers may require the marital status of the driver and one carrier may allow values of “Single”, “Married”, “Divorced” and “Separated” while another carrier may allow values of “S” (for single), “M” (for married), “D” (for divorced), and “W” (for widowed). In this example, the interpreter will collate the value selected and map the “Single” value to an “S” value or a “W” value to a “Married” value if that particular carrier defines a widowed driver as married.

The interpreter uses a data mapping engine 16 that matches the user input variables with a quote request form of each carrier, including all carrier/market specific rating variables that would otherwise be validated only at the carrier's website after submission. The interpreter transmits the third party request form to the third party, receives a quote, and extracts the relevant information from the quote. The interpreter can then collate the quote information from all of the third party insurance providers and present comparative quote information to the user in a convenient format. The quote information may be displayed on the user interface, emailed, provided as a hyperlink or printed and posted to the user. The interpreter also uses this same data mapping engine 16 to transmit the quote request for closing and binding the quote request.

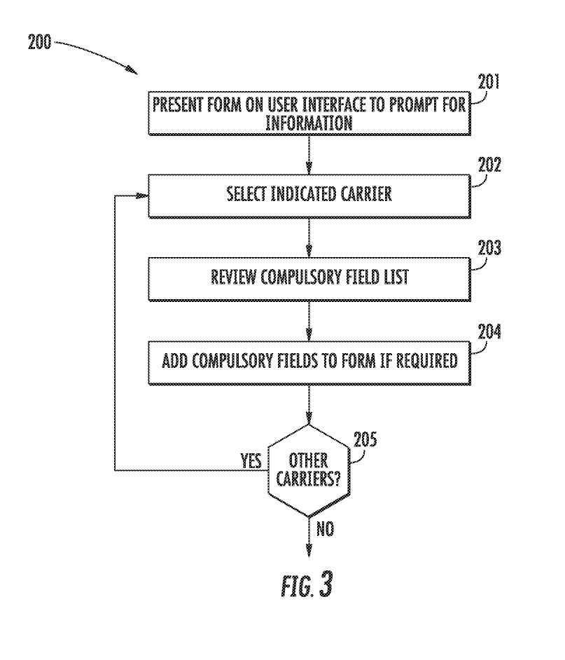

An example of a process for receiving quote request information from a user is shown in the flowchart 200 of FIG. 3. The example is provided in the context of quotes for insurance carriers, though a person skilled in the art will understand that quotes from other types of third party service providers may be obtained by the same methods. At step 201, the interpreter 14 presents a display, such as a web-based form on the user interface 12 that prompts the user for information. The information requested, may include an insurance type. The information requested may allow a user to specify any insurance carriers of interest, with all carriers being selected as a default. The interpreter then determines whether the user has provided the required information for each insurance carrier (or each specified carrier) for the specified insurance type as follows. A first indicated carrier is selected (step 202) for which the interpreter reviews the compulsory field list for the indicated insurance type (step 203) and determines whether additional compulsory fields need to be added to the form (step 204). Fields may already be included on the form, but may be updated to indicate that these forms are compulsory. If there are other carriers to be considered (step 205), then the process returns to step 202 and is repeated for each carrier of the system or for each carrier that is to be included in the comparative quote.

Since some fields may be compulsory only for some carriers, the user interface may only display fields that are compulsory for at least one of the selected carries. If the user adds carrier that has a compulsory field that is not already indicated on the form as a compulsory field, the field may be added as a compulsory field on the form, e.g., by adding the field or by changing an indicator of the field to indicate that the field is now compulsory.

It should be noted that compulsory fields may not be compulsory for all carriers. However, in order to obtain a comparative quote for all selected carriers, the compulsory fields of each carrier must be satisfied. The form may also indicate other non-compulsory fields that enable a user to receive a more tailored quote. However, not all carriers may use the information of the non-compulsory fields.

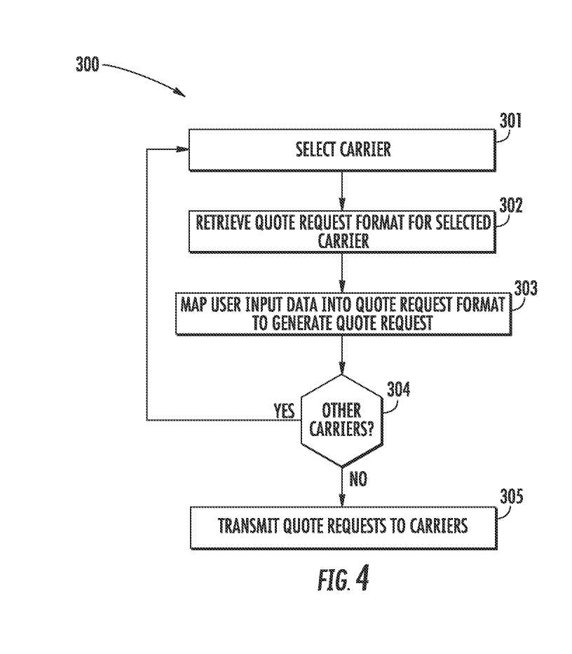

A process for providing the quote requests to the third party carriers is shown in the flowchart 300 of FIG. 4. At step 301, the interpreter commences processing the user input form by selecting a first of the indicated carriers specified in the form and retrieving a quote request format for the carrier (step 302). The data mapping engine 16 of the interpreter 14 then maps the data of the user input form into the quote request format (step 303). If quote requests are to be generated for other carriers, then the process returns to step 301 and the process is repeated for each carrier indicated in the form. At step 305, the individual quote requests are then transmitted to the respective carriers 18 via carrier bridges 17.

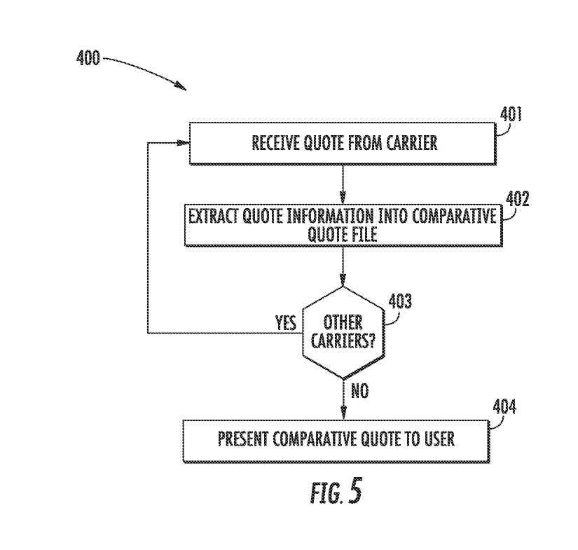

The interpreter manages data interfaces with any third party rater able to export data to a carrier bridge. The interpreter captures this rater supplied data file and converts it to a standardized file format for providing a comparative quote. A process for generating a comparative quote is shown in the flowchart 400 of FIG. 5. At step 401, a first quote is received from a first carrier in a quote file. The quote file is processed to extract the quote information, which is added to a comparative quote file (step 402). The comparative quote file may include a number of fields, such as premium, quote date, period of insurance, a list of what is covered, a list of exclusions, etc. These headings may be provided for each carrier to be included in the quote, e.g., in a table format. If more quotes are to be received (decision step 403), then the process 400 returns to step 401 and is repeated for each quote received. Once each quote has been processed and the data mapped into the comparative quote file, the result may be a table of comparative quote information that may be presented to a user in any convenient format (step 404).

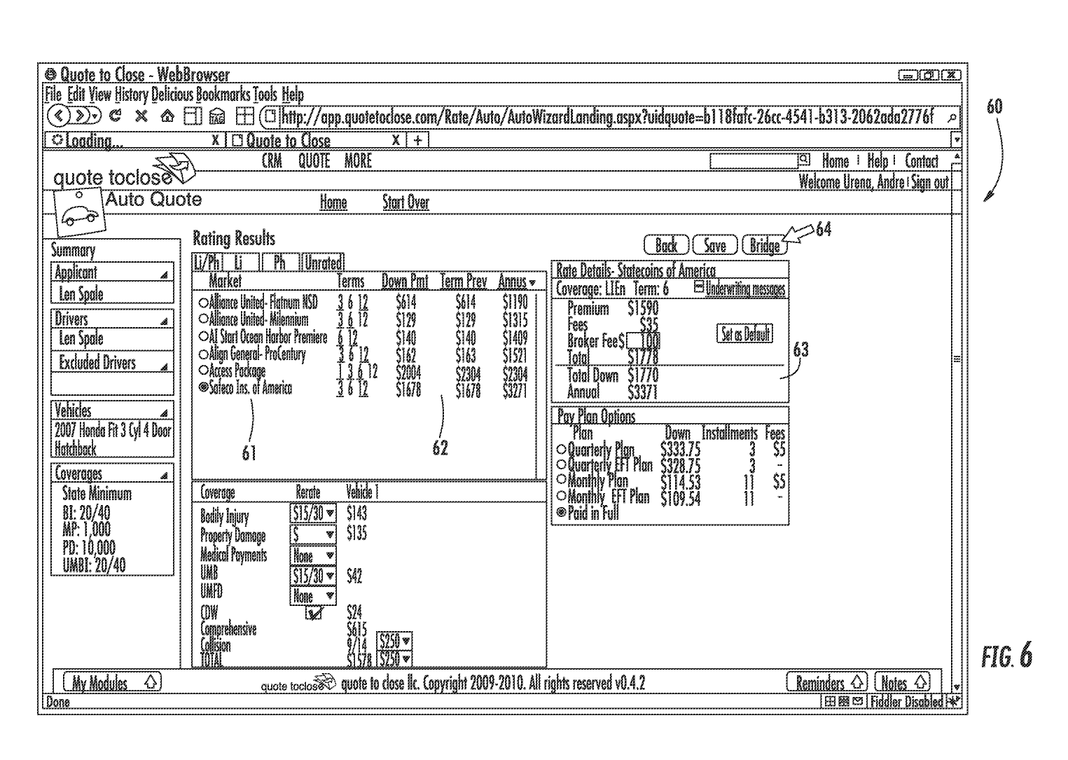

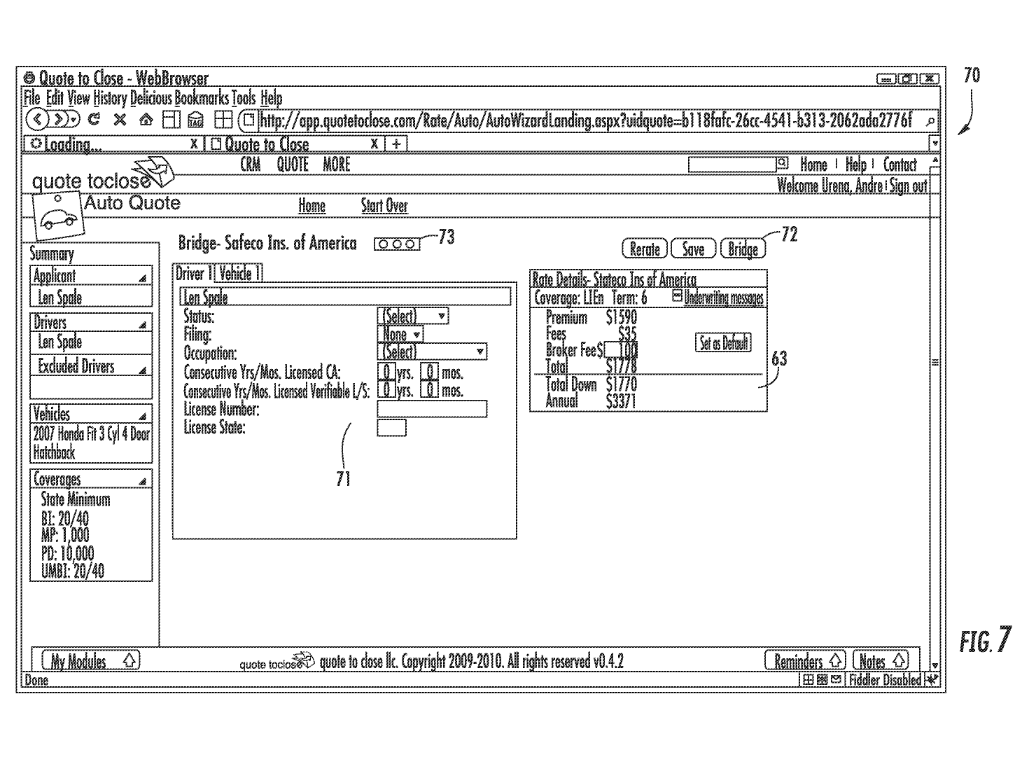

An example interface 60 is shown in FIG. 6. The interface 60 displays to a user a comparative quote list including a list of insurance carriers 61 and a corresponding list of premiums 62. A user may select an indicated carrier from the quote list 61 to be shown more specific details 63 of a particular quote. A bridge icon 64 is presented on the display 60. Selection of the bridge icon 64 by the user moves the user to a specific screen 70, shown in FIG. 7, pertaining to the selected quote for the selected carrier. The display 70 prompts the user to confirm details 71 that enable the carrier to bind the quote between the user and the carrier. The details required may be more than the details required to provide an indicative quote for the quote comparison. Thus, any missing details may be determined by the data mapping engine 16 and displayed on the interface 70. Certain details may be mandatory and thus may be differentially highlighted on the display 70. Until all mandatory fields are completed, a bridge button 72 may be disabled and a validation indicator 73 may be set to red.

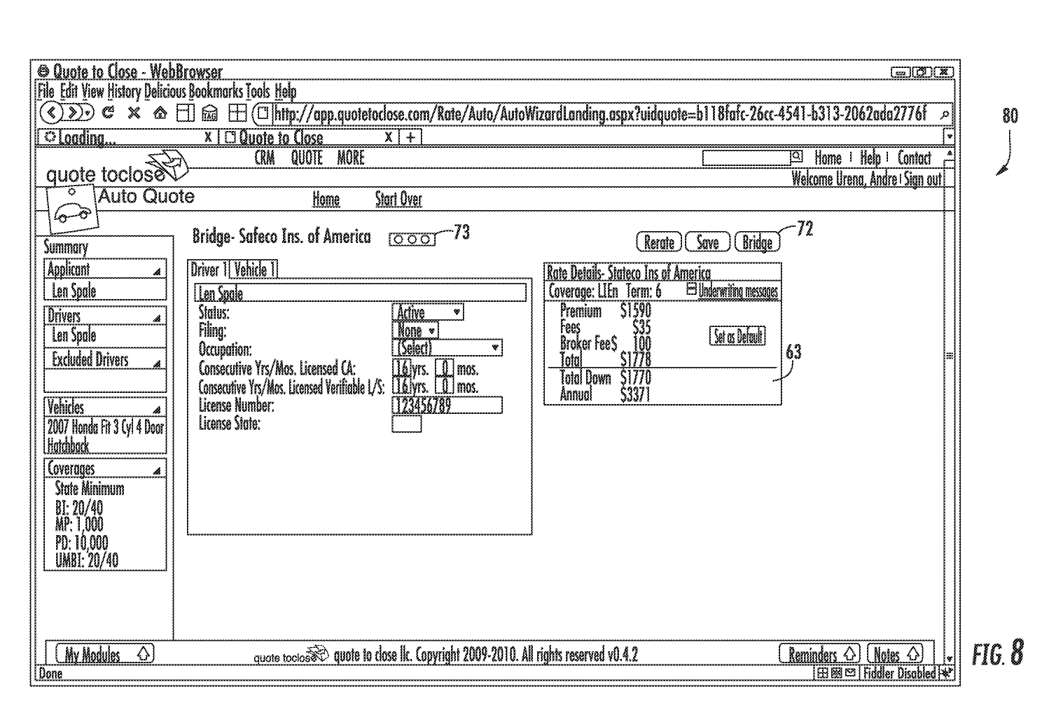

Once all rate bearing variables, i.e. mandatory variables have been entered or confirmed, as shown in the display 80 of FIG. 8, the validation indicator 73 may be set to yellow and the bridge button 72 may be enabled. Any missing variables at this stage are part of a carrier specific application, but have no effect in rating. Thus the user has the option of skipping these or completing these variables until the indicator 73 changes to green. Selection of the bridge icon 72 causes the user details to be bound into an accepted quote that is then sent to the respective carrier.

An advantage of the interpreter is that it identifies data gaps in quote applications required by the selected carrier and requires the users to complete this information before submitting it. Using the interpreter, users such as insurance agents may be provided with accurate pricing at point of sale in real-time. In addition, the interpreter enables re-use of data captured during each quotation process.

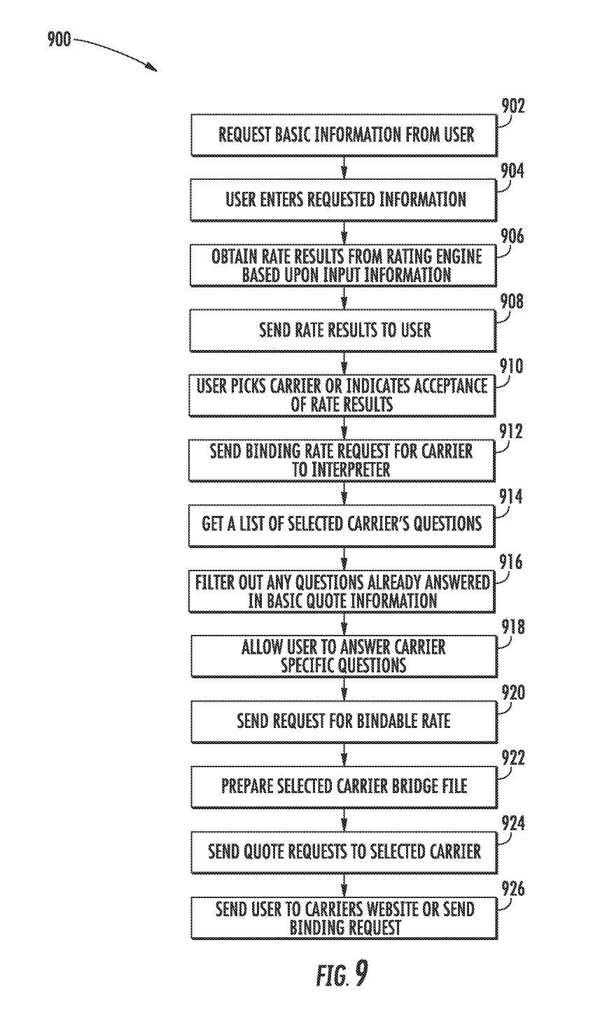

As seen in FIG. 9, the present invention comprises a method for providing a quick quote to a user. In step 902, the system requests basic information from the user. This information may be very preliminary information, such as age, gender, zip code, address, type of policy, etc. In step 904, the user enters requested information. In step 906, the system obtained rate results from a reading engine based upon information input by the user. The system sends rate results to the user in step 908. The user then picks a carrier or indicates acceptance of a rate result in step 910.

In step 912, the system sends binding rate request information for a carrier to the interpreter area. The system then get a list of selected carrier questions, in step 914. In step 916, the system filters out any questions already answered by the user in the basic quote information. The system then transmits the specific questions to the user and the user is allowed to enter information in response to those questions, step 918. Once all of the appropriate information has been entered, the system sends a request for a binding quote to the carrier in step 920. In step 922, the system prepares a selected carrier bridge file. The system sends a quote request to the selected carrier in step 924. In step 926 the system may send the user to the carrier specific website or the system may prompt the user to enter into an agreement with the carrier.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for generating a comparative quote comprising:
(A) receiving a plurality of input parameters from a user;
(B) converting the plurality of input parameters into a plurality of quote requests in a plurality of third party request formats;
(C) transmitting the plurality of quote requests to a plurality of third parties, each request to a third party being sent in the third party request format of the respective third party;
(D) receiving a plurality of quotes from the plurality of third parties;
(E) collating the plurality of quotes into a comparative quote; and
(F) providing the comparative quote to the user.

2. The method of claim 1 comprising:
(A) determining a first third party to receive a quote request;
(B) determining a third party request format for the first third party;
(C) determining one or more compulsory parameters of the third party request format for the first third party;
(D) determining whether the input parameters include each compulsory parameter of the third party request format for the first third party; and
(E) notifying the user if the input parameters do not include each compulsory parameter of the third party request format for the first third party.

3. The method according to claim 1 comprising:
(A) receiving an indication from the user of an accepted quote; and
(B) transmitting the quote information of the accepted quote to the respective third party pertaining to the accepted quote to bind the quote.

4. A method of request information from a user for an insurance quote using at least one computer and a communication network, the method comprising, not all necessarily in the order shown:
(A) the computer transmitting over the communication network a request for information relating to at least one variable to a user;
(B) the computer receiving over the communication network input information from the user in response to the request;
(C) the computer calculating an average insurance premium based at least in part on the input information; and
(D) the computer transmitting over the communication network the average insurance premium to the user.

5. The method of claim 4 wherein the variable is selected from the group consisting of:
(A) zip code;
(B) address;
(C) age; and
(D) type of insurance.
